(19) United States
(12) Patent Application Publication
(10) Pub. No.: US 2002/0188719 A1
(43) Pub. Date: Dec. 12, 2002

(54) Communication between an application and a network element

(75) Inventors: Hien-Thong Pham, Brussels (BE); Dominique Chantrain, Edegem (BE); Claudine Batsleer, Scheldewindeke (BE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/116,039

(22) Filed: Apr. 5, 2002

(30) Foreign Application Priority Data
May 29, 2001 (EP) 01 440 146.7

(51) Int. Cl. G06F 15/173

(52) U.S. Cl. 709/224; 709/218

(57) ABSTRACT

Network elements (NE) of a telecommunications network and an application platform (SP), which provides value-added services on top of the network, communicate with each other by means of triggers (T) and handles (H). Triggers (T) are notifications containing information to be sent by a network element to the application platform (SL) upon occurrence of predefined events and handles (H) are commands to be sent by the application platform (SL) requesting execution of predefined actions at said network element (NE). A network element (NE) includes a management information base (MIB) containing managed objects, which describe variables and parameters accessible by a network management system (NMS) to control and monitor the network element (NE). In order to allow systematic interrogation of the triggers and handles interface of a network element (NE), its management information base (MIB) stores additional managed objects which describe the triggers (T) and handles (H) supported by said network element (NE). A software module (NID), which is part of the application platform actively interrogates the network element (NE) to find out which triggers (T) and handles (H) the network element (NE) supports. The module sends requests to the network element and stores in a data model (THB) information on the interface received back from the network element (NE).

### FIELD OF THE INVENTION

The invention relates to the communication between network elements of a telecommunications network and an application platform particularly in IP networks.

### BACKGROUND OF THE INVENTION

Today telecommunications networks and especially IP networks (IP: Internet Protocol) are evolving towards more types of network elements, more functionality, more protocols, more service support, etc. However, to allow applications, which implement services, to use these functions, mechanisms are needed to send information on network events from network elements to the applications platform.

As network elements are becoming more intelligent and supporting more functions, applications need mechanisms to interact with these network elements: sending commands, e.g., to establish connections, to control routing and NAT tables (NAT: Network Address Translation), etc., and receiving notifications when certain events occur, e.g. information on user presence and location when a user starts a session. Many of these functions are as such already available through existing protocols and network element interfaces. However, although the protocols themselves are standardized to a certain extent, there is no way to know whether a given network element supports a given notification or a given command, which version/variant it supports, etc. unless by manually inspecting the user manuals of the equipment.

For application platforms running on top of heterogeneous networks (i.e. multiple types of network elements from different vendors), this implies that configuring the application platform such that it uses the correct notification and command variant to each individual network element is a tremendous task, with important operational costs.

The problem is that today a mechanism is lacking through which application platforms can find out what functions, protocols, notifications, and commands a network element offers on their interfaces.

### SUMMARY OF THE INVENTION

It is therefore an object of the present invention to provide a network element and associated management information base, which can be actively investigated by an application on its abilities.

These and other objects that appear below are achieved by an network element and related management information base that describes the triggers and handles interface of a network element. A management information base is a database which contains managed objects, which describe variables and parameters accessible by a network management system to control and monitor the network element. This database stores additional managed objects which describe the triggers and handles supported by said network element. The triggers are notifications containing information to be sent by said network element to an application upon occurrence of predefined events and the handles are commands to be sent by an application requesting execution of predefined actions at said network element.

The existence of these additional objects allows an application platform to automatically discover and adapt to the interfaces supported by network elements. This is increasingly important as networks get more and more complex and diverse. The introspection does not depend on any specific software technologies used in the application platform or the network element. It may make use of the SNMP protocol which is today supported by the majority of network elements to enable network management.

A trigger is a piece of information sent by a network element to the service logic whereas a handle is a command sent by the service logic to a network element.

Another object of the present invention is to provide an application and related software module which enables to interrogate the interface of a network element.

These objects are achieved by a software module which is part of an application platform. The software module is adapted to interrogate an interface of a network element to find out which triggers and handles the network element supports. The module sends requests to the network element and stores in a data model information on the interface received back from the network element.

### BRIEF DESCRIPTION OF THE DRAWINGS

A preferred embodiment of the present invention will now be described with reference to the accompanying drawings in which

FIG. 1 shows in general the interworking between network layer and application layer in a telecommunications network;

FIG. 2 shows in more detail the reference network configuration used in the specific embodiment; and

FIG. 3: shows the interrogation of a network element and the communication between an application and a network element using triggers and handles.

### DETAILED DESCRIPTION OF THE INVENTION

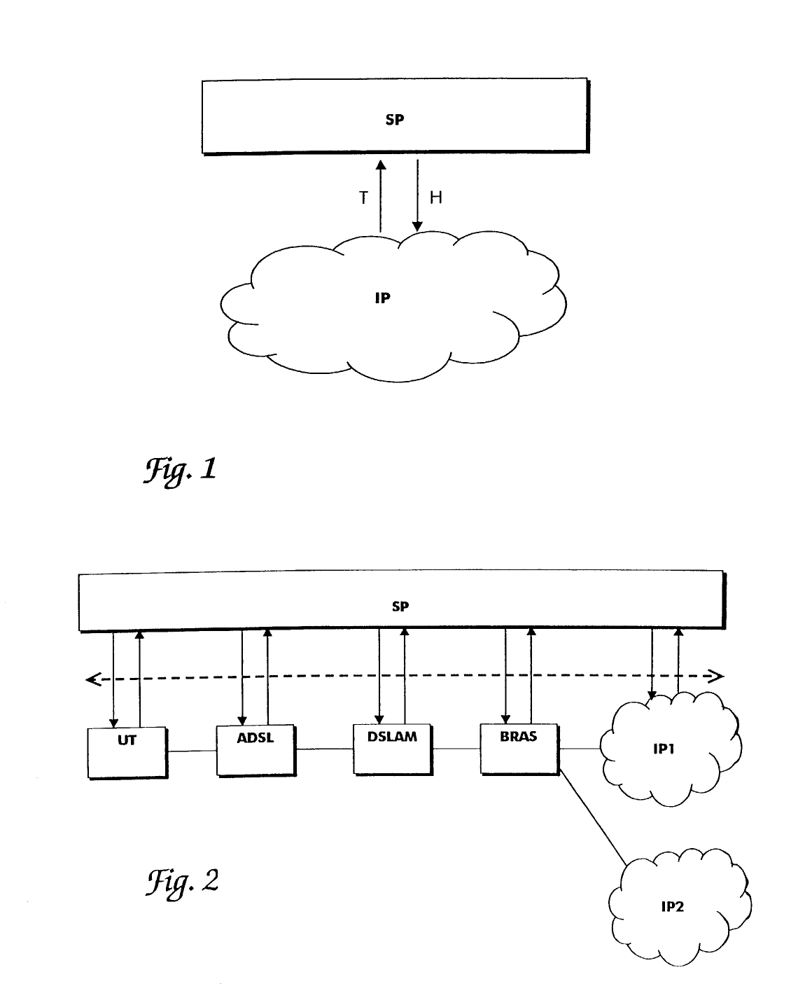

The general architecture of a telecommunications network and service logic is shown in FIG. 1. The telecommunications network IP includes several interconnected network elements. A service platform SP provides telecommunications services on top of the network. The service platform SP may either be a single application running on a user terminal, on a server in the network, or may be a distributed service platform which includes several software modules each or some in combination offering a certain service to an end-user.

Network element means any network device including network connectivity capability like access network elements and core network elements. In the specific embodiments, the telecommunications network is an IP network and the term network element thus includes core routers and edge routers, broadband access servers, digital subscriber line equipment, modems, and the like. The network elements perform any functions belonging to the network layer. On the other hand, the service logic is a set of high-level applications providing value-added services to end-users and is not concerned with network connectivity services. The service logic therefore represents the application layer. The term application means any software module running in the service logic.

According to the present invention, service logic SP and network elements of the network IP communicate with each other by means of triggers T and handles H. A trigger T is a piece of information sent by a network element to the service logic SP whereas a handle is a command sent by the service logic SP to a network element. More specifically, a trigger is a notification containing data sent by a network element to the service logic SP upon occurrence of a specific network event. Triggers are thus a way for network elements to provide information that can be used by the service logic SP and that, somehow, participate in value-added services visible to end-users. An example of a trigger is a presence trigger used by the service logic for billing, for advertisement, etc. A handle H is a command sent by the service logic to a network element. These commands for example request the network element to execute some actions like configuration of QoS (Quality of Service), setup of connections, update a router table, etc, the network element is capable of among all its networking capabilities. Handles can as well contain useful information. Handles are thus a way to drive network resources for the benefit of a service platform.

The network architecture that will be used in the following specific embodiment is shown in more detail in FIG. 2. It comprises a user terminal UT connected to an ADSL (Asymmetric Digital Subscriber Line) modem ADSL. Via a digital subscriber line, the ADSL modem is connected to the DSL equipment DSLAM of an access provider. The DSLAM is connected to a broadband remote access server BRAS of the provider and to the BRAS, two IP networks IP1, IP2 of two different network providers are connected.

Each of these devices, i.e., the user terminal, the ADSL modem, the DSLAM and the BRAS as well as network elements of the two IP networks communicate with the service platform SP by means of triggers and handles. Network layer and application layer are separated in the figure by a broken line.

A basic idea of the present invention is to introduce a new type of Management Information Base (MIB) that describes the triggers and handles interfaces of a network element. Via this MIB, an application platform can then use the Simple Network Management Protocol (SNMP) to request information on the interfaces of the network element, such as for example:

Get list of supported triggers and handles.

For a given trigger, get the triggering event.

For a given trigger or handle, get list of parameters supported (indicating for each parameter whether it is optional or mandatory).

A management information base (MIB) is a formal description of a set of network objects that can be managed using a protocol like SNMP.

A traditional MIB is used for the sole purpose of network management, i.e., to control and monitor the network elements in the network. From the perspective of a network manager, network management takes place between two major types of systems: those in control, called managing systems, and those observed and controlled, called managed systems. The most common managing system is called a network management system (NMS). Managed systems can include hosts, servers, or network components such as routers or intelligent repeaters.

To promote interoperability, cooperating systems must adhere to a common framework and a common language called a protocol. In the Internet Network Management Framework, that protocol is the Simple Network Management Protocol (SNMP).

In a managed device, specialized low-impact software modules, called agents, access information about the device and make it available to the NMS. Managed devices maintain values for a number of variables and report those, as required, to the NMS. For example, an agent might report such data as the number of bytes and packets in and out of the device, or the number of broadcast messages sent and received. In the Internet Network Management Framework, each of these variables is referred to as a managed object. A managed object is anything that can be managed, anything that an agent can access and report back to the NMS. All managed objects are contained in the Management Information Base (MIB), a database of the managed objects.

An NMS can control a managed device by sending a message to an agent of that managed device requiring the device to change the value of one or more of its variables. The managed devices can respond to commands such as set or get commands. The set commands are used by the NMS to control the device. The get commands are used by the NMS to monitor the device.

The MIB of a network element is defined specifically for this network element in a high-level language like ASN.1 (Abstract Syntax Notation One), which is a formal language for abstractly describing messages to be exchanged between distributed systems. The MIB defines the set of managed objects this NE supports. These objects are organized as a tree where they inherit from existing objects. The ASN.1 file containing the MIB description is then compiled by a tool together with Managed Object Agents that are used to manipulate the Managed Objects. The resulting file is an executable file, which is part of the software of the network element. This software file is then downloaded at startup time to the network element from the NMS. At run-time, the NMS interacts with Manager Object Agents using a protocol like SNMP to modify states of Managed Objects. In the NMS, there exists an image of the MIB that reflects the current state of the MIB residing in the network element.

According to the present invention, use is made of the MIB by an application platform to interrogate the triggers and handles the network element supports. Therefore, the MIB contains new managed objects describing the supported triggers and handles. Via NMS, the network element is configured to include in its MIB the relevant managed objects for the supported interfaces to the application platform. Triggers and handles can thus be seen as new managed objects to be added as an extension to the MIB of the network element.

The network element comprises further to the MIB with its new managed objects one or more software agents which serve to access and maintain the new managed objects for triggers and handles and make upon request from an application the information on the supported triggers handles available.

Another aspect of the present invention consists in the introduction of a new module into the application platform, the Network Interface Discovery (NID) module. The role of the NID module consists in:

Obtaining the complete information on triggers and handles interfaces supported by a network element, by using an algorithm to systematically interrogate the MIB. The algorithm will typically collect the information by sending a sequence of requests, e.g., get all interfaces, for each interface get list of messages, etc. and

storing this information in a data model in the application platform, where it will be accessed by applications. When an application wants to check if a trigger or handle is supported by a certain network element, it may check this data model.

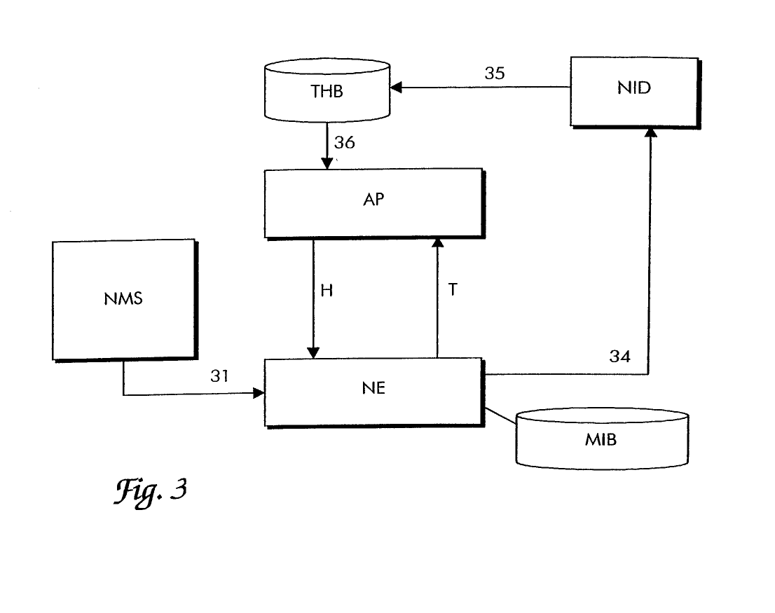

The communication between an application AP and a network element NE using triggers T and handles H is shown in a first embodiment in FIG. 3. A network management system NMS configures in a first step 31, a list of supported triggers and handles by provisioning network element NE with a management information base MIB containing corresponding managed objects. The MIB is stored in a database on a permanent storage of the network element NE. In step 34, a Network Interface Discovery module NID interrogates the network element by sending requests as explained above to the network element and receiving back pieces of information on the supported triggers and handles. These pieces of information are stored in step 35 in a trigger and handle database THB in the application platform to which the application AP belongs. If application AP wants to send a command to the network element, it consults in step 36 database THB to check which handle version the network element NE supports and sends the appropriate handle H. When a specific network event occurs, the network element NE sends to the application AP a trigger T indicating to the applications AP that this specific event has occurred.

The trigger and handle database THB may be any kind of data model suited to store in a structured way the information on triggers and handles received from one or more network elements and may be implemented on a permanent storage of any kind.

The NID module as described above may be part of a single application or a distributed application platform. Nevertheless, its functions may also be included directly into a single application instead of providing a distinct software module.

The interface interrogation according to the present invention con to advantage be used in combination with a subscribe/notify mechanism as described in the co-pending European potent application entitled “Trigger between Service Platform and Network Element”, application number EP 01 440 129.3, filed on Oct. 5, 2001, which is incorporated by reference herein.

The basic concept of this subscribe/notify mechanism is that an application subscribes with a network element for triggers it is interested to receive by sending an appropriate subscription request to the network element. The subscription request specifies the event that is to be notified to the application and the parameters the application is interested to receive. Upon occurrence of an event of the specified type, the network element generates and sends to the subscribed application a trigger message including the requested trigger parameters.

In order to benefit best of the subscribe/notify mechanism, it is advantageous that the application investigates the interfaces of the network element, first, to see what triggers the network element offers for subscription and what triggers parameters would be available. In the example shown in FIG. 3, this means that the Network Interface Discovery module NID sends in step 34 investigation requests like “Get list of supported triggers and handles.” and. “For a given trigger, get list of supported parameters.” to the network element NE. The information received back from the network element NE are then stored in database THB. The application AP can thus look into database THB to see what triggers and trigger parameters the network element NE offers. Then application AP subscribes to the network element for a certain trigger and upon occurrence of the corresponding trigger event, network element NE send the requested trigger T to the subscribed application AP.

The following example shows how triggers or handles can be defined as managed object using ANS.1.The example describes Radius, COPS (Common Open Policy Service) and Diameter handles for a broadband remote access server (BRAS) as the one shown in FIG. 2. The figures are used to illustrate one example, only, and may be different for other examples. For the accounting attributes the same attribute id (i.e. username=attribute 1, acct-statustype=40) are used as in RFC2139 for Radius accounting which is incorporated by reference herein.

```
x. 19 brasHandles
-- x.19.1 AAAHandles
-- x.19.1.1 RadiusHandle
-- x.19.1.1. Accounting
-- x.19.1.1. AccountingRFC
-- x.19.1.1. AccountingAttributes
-- x.19.1.1.1 AcountingUsername
-- x.19.1.1.40 AccountingAcct-StatusType
-- x.19.1.2 CopsHandle
-- x.19.1.1.1 DiameterHandle
-- x.19.2 ConnectionSetupHandles
bras OBJECT IDENTIFIER ::= { iso(1) org(3) dod(6) internet(1)
private(4) enterprises(1) assured access (304 1) 1 }
Handles OBJECT IDENTIFIER ::= { bras 19 } -- Supported handles/
protocols MIB
  AAAHandles OBJECT IDENTIFIER ::= {Handles 1 }
  ConnectionSetupHandles OBJECT IDENTIFIER ::= { Handles 2 }
.....
      RadiusHandle OBJECT IDENTIFIER ::= { AAAHandles 1 }
      CopsHandle OBJECT IDENTIFIER ::= { AAAHandles 2 }
      DiameterHandle OBJECT IDENTIFIER ::= { AAAHandles 3 }
Accounting OBJECT IDENTIFIER ::= { RadiusHandles 1 }
AccountingRFC OBJECT-TYPE
  SYNTAX INTEGER
  ACCESS read-write
  STATUS mandatory
  DESCRIPTION “compliant to RFCxxxx”
  ::= { Accounting 1 }
AccountingAttributes OBJECT IDENTIFIER ::= { Accounting 2 }
AcountingUsername OBJECT-TYPE
  SYNTAX STRING
  ACCESS read-write
  STATUS mandatory
  DESCRIPTION “describes the username attribute”
  ::= { AccountingAttributes 1 }
AccountingAcct-StatusType OBJECT-TYPE
  SYNTAX STRING
  ACCESS read-write
  STATUS mandatory
  DESCRIPTION “describes the possible values of the accouting status
  eg. “start(1), stop(2),...”
  ::= { AccountingAttributes 40 }
```

Having now described the invention with respect to a preferred embodiment, it should be understood by those skilled in the art that various other changes, omissions, and additions would be possible without departing from the scope and spirit of the invention. It is to be noted that for example the introduction of the NID module functionality into the application platform is not necessarily required for the implementation of the invention. Instead of interrogating the interface of a network element in advance and storing the information on its interface in a data model, it would also be possible to ask a network element each time a handle is to be sent or each time a subscription to a trigger shall be made, whether the network element supports this trigger or handle and which version and parameters it supports. However, it is preferred to interrogate any supported triggers and handles in advance in order to minimize network traffic.

Another advantageous modification would be the introduction of an additional software module into the application platform, the Network Interface Adaptation (NIA) module. The role of the NIA module consists in:

Translating commands issued by applications, in a protocol independent way, e.g., set NAT table to allow for traffic between (IP address a, port x) and (IP address b, port y) towards the specific protocol message or the specific handle for the given network element.

Translating triggers from network elements, e.g., RADIUS accounting message or any other trigger, into the network independent representation of triggers used internally in the application platform.

What is claimed is:

1. A management information base for a network element, said management information base being a database comprising managed objects describing variables and parameters accessible by a network management system to control and monitor said network element, wherein the management information base further comprising additional objects describing triggers and handles supported by said network element, said triggers being notifications containing information to be sent by said network element to an application upon occurrence of predefined events and said handles being commands to be sent by an application requesting execution of predefined actions at said network element.

2. A network element comprising a management information base being a database comprising managed objects describing variables and parameters accessible by a network management system to configure and control the network element, wherein the management information base further comprising additional objects describing triggers and handles supported by said network element, said triggers being notifications containing information to be sent by said network element to an application upon occurrence of predefined events and said handles being commands to be sent by an application requesting execution of predefined actions at said network element.

3. A network element according to claim 2, further comprising at least one software agent adapted to access and maintain said additional objects and serving to make upon request from an application the information on the supported triggers and handles available to the application.

4. A software module as part of an application, said software module being adapted to interrogate an interface of a network element to find out which triggers and handles the network element supports by sending requests to the network element and storing in a data model information on the interface received back from the network element, said triggers being notifications containing information to be sent by said network element to an application upon occurrence of predefined events and said handles being commands to be sent by an application requesting execution of predefined actions at said network element.

5. A software module as claimed in claim 4 using Simple Network Management Protocol to send said requests to a network element.

6. A software module as claimed in claim 4, wherein said requests comprising at least one request from the list
get list of supported triggers and handles;
for a given trigger, get the triggering event; and
for a given trigger or handle, get list of parameters supported.

7. An application comprising a software module adapted to interrogate an interface of a network element to find out which triggers and handles the network element supports by sending requests to the network element and storing in a data model information on the interface received back from the network element, said triggers being notifications containing information to be sent by said network element to an application upon occurrence of predefined events and said handles being commands to be sent by the application requesting execution of predefined actions at said network element.

8. A method of interrogating a network element by an application to find out which triggers and handles the network element supports, said triggers being notifications containing information to be sent by said network element to an application upon occurrence of predefined events and said handles being commands to be sent by an application requesting execution of predefined actions at said network element, said method comprising the steps of
sending at least one request to the network element and
storing in a data model information on the interface received back from the network element.

9. A method according to claim 8, further comprising the steps of
upon reception of the request at the network element, accessing managed objects to retrieve the requested information, said managed object being stored in a management information base in the network element and describing triggers and handles supported by said network element, and
sending the retrieved information back to the application that initiated the request.

10. A method according to claim 8, wherein said at least one request being one from the list
get list of supported triggers and handles;
for a given trigger, get the triggering event; and
for a given trigger or handle, get list of parameters supported.
